(19) United States
(12) Patent Application Publication
(10) Pub. No.: US 2026/0160526 A1
(43) Pub. Date: Jun. 11, 2026

(54) BATTERY SET

(71) Applicant: On-Point Defense Technologies LLC, Fort Walton Beach, FL (US)

(72) Inventors: Robert L. Comstock, Hancock, MI (US); Matthew Thomas Miller, Houghton, MI (US); Nathan C. Wichers, Houghton, MI (US)

(21) Appl. No.: 19/413,693

(22) Filed: Dec. 9, 2025

Related U.S. Application Data
(60) Provisional application No. 63/730,600, filed on Dec. 11, 2024.

(51) Int. Cl. F41G 7/30; H01M 10/42; H01M 50/204; H01M 50/249

(52) U.S. Cl. CPC F41G 7/301; H01M 10/425; H01M 50/204; H01M 50/249; H01M 2220/20

(57) ABSTRACT

An MGS battery system which is designed as a drop in substitute for the existing MGS battery pack in an FCS for use with a TOW platform. The MGS battery system provides for a single integrated power source which can provide for electrical power to a variety of different output ports that each have different supply requirements. The MGS battery system takes in multiple inputs to supply the power to charge onboard batteries. The MGS battery system can handle the multiple inputs and the multiple outputs while only utilizing a single power conversion stage for each electrical path.

### CROSS REFERENCE TO RELATED APPLICATION(S)

This application claims the benefit of U.S. Provisional Patent Application Ser. No. 63/730,600, filed Dec. 11, 2024, the entire disclosure of which is herein incorporated by reference.

### BACKGROUND OF THE INVENTION

### Field of the Invention

This disclosure relates to the field of battery packs and systems and particularly to battery power systems for powering portable missile systems and related electronics.

### Description of the Related Art

Produced since 1970, the TOW (“Tube-launched, Optically tracked, Wire-guided”) missile is one of the most utilized guided anti-tank missiles in the world. The concept of the weapon is relatively straight-forward. The missile is mounted inside a dedicated launch tube which is aimed at the target. Aiming is typically accomplished by a human operator utilizing a Target Acquisition System (TAS) which provides some form of a visual sight either relying on daylight or infrared (IR) night-vision. When triggered, the missile leaves the launch tube and is propelled toward the target. Originally, the missile would trail guiding wires through which communication information could be sent from the launcher to the missile, which is where it got its original moniker. More modern versions, however, can now use wireless signals in the same way.

An infrared (IR) beacon in the missile's tail is located by the TAS and provided to a Flight Control Subsystem which allows the location of the missile to be tracked during flight and that allows for the flight to be adjusted based on the position of the reticle in the aiming system. The reticle is maintained on the target during the missile's flight by the operator and this steers the missile. Feedback between the operator's positioning of the reticle and the detected position of the missile is transmitted via the wires or wireless connection to flight surfaces of the missile to allow it to be directed into the target identified by the reticle positioning. Specifically, that it will impact the point indicated by the operator as the target.

TOW missiles are very versatile with one of the key aspects of their value and pervasiveness being their ability to be launched from a variety of platforms and carry a variety of warheads. These include where the missile is launched by infantry from a modular tripod mount that breaks down into a number of components, to use on secondary mounts for vehicles, to use on dedicated armored vehicles designed to utilize TOW missiles as their primary armament. While these systems all ultimately utilize the same missiles, it is important to recognize that their support systems and missile launchers are often quite different to deal with their differing battlefield realities.

FIG. 1 provides an embodiment of a tripod mounted TOW missile platform (10) designed primarily for infantry use. In the embodiment of FIG. 1, the platform (10) is able to break down into smaller components which can be transported both in trucks and other vehicles and by hand. A major concern for such a broken down platform (10) is weight. The platform (10) will typically include mechanical components such as the physical launch tube for holding the missile (which is inside its own tube) (11), a tripod for stability (13), a traversing unit (15) to allow the launch tube to be moved, and both a daysight (17) and optional night sight (19). Attached to this by an umbilical cable (21) is a Fire Control System (FCS) module (31). The FCS (31) provides various computational support to the platform (10) and includes a Missile Guidance System (MGS) (33). The MGS (33) essentially provides much of the control of the platform (10) and is what is actually hooked to the umbilical (21).

Also within the FCS (31) is an MGS battery pack (35) which is co-mounted with the MGS (33) in the FCS (31). The battery pack (35) serves to provide power to the electronics of the MGS (33). However, while the power consumption from the battery pack (35) is via the MGS (33), which can also feed power to other components (such as elements of the daysight (17)) via the umbilical (21), those working with TOW platforms (10) typically require power for other non-launch systems as well. Most importantly, the night sight system (17) requires power and has not typically been supplied with power via the umbilical (21). The night sight system (17), therefore, has typically required a second battery pack be provided and this battery pack has typically not been rechargeable. All of these components need to be carried, often by hand, as the platform cannot rely on power being available from vehicles, generators, or the like due to its intended battlefield role.

Specifics for the requirements of the MGS battery pack (35) and charger equipment have previously been specified via dictated requirements. The MGS battery pack (35) was always intended to be taken into the field and to provide power to the MGS (33), and systems connected thereto, through multiple firings without recharge. However, in recent years, the legacy battery pack (35) has proven less and less capable of meeting this need and the MGS battery pack (35) has been totally unusable for powering the night sight (17). One reason for this is because the legacy batteries utilize Nickel-Cadmium (NiCad) technology.

NiCad batteries were developed in the late 1800s and by 1950 had been made into a sealed form. They dominated the supply of rechargeable batteries until the 1990s when new technologies such as those based on lithium, which tend to hold more charge over longer time and for less size, began to take over the market. For the most part, NiCad rechargeable batteries have ceased to be readily commercially available. However, they are still in use in MGS battery packs (35).

In practice, the NiCad batteries in MGS battery packs (35) have proven to degrade significantly over time resulting in a high scrap rate, systems failing to meet specifications, failing mission requirements, and high replacement costs due to the general unavailability of chemicals and parts. Further, they are cumbersome and heavy for the soldier to utilize. Further, with the increased commonality of night sight systems (19) on TOW platforms (10), there has been a need for a second battery set to be carried as the existing MGS battery pack (35) is incapable of supplying the type of power needed by the night sight (19) because the night sight (19) and the requirements of the missile (11) itself tend to require different electrical inputs. Finally, the NiCad batteries used in the battery pack (35) also require technology specific chargers which contain obsolete electronics making them not only costly to build and replace but confining recharging operations to the locations of these specific charging stations.

In recent years, increased electrification using rechargeable chemical batteries for everything from power tools, to the prevalence of mobile computing devices and smartphones, to vehicles have resulted in tremendous leaps in battery technology. Further advancements in electronics and charger technologies have provided clear opportunities to improve the MGS battery pack (35) to allow for better operation. As part of this upgrade, it is also possible to provide more integrated battery systems for use with TOW missile platforms (10) to make them more reliable, reduce weight and space, and significantly improve performance while reducing production and sustainment cost. However, these batteries and associated technologies have not been drop-in substitutes in existing MGS battery packs (35) that rely on NiCad batteries and all the desired increases in functionality (and reduction in weight) require a completely redesigned MGS battery pack (35).

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is an MGS battery system (100) which is designed as a drop in substitute for the existing MGS battery pack (35) in an FCS (31) for use with a TOW platform (10). The MGS battery system (100) typically utilizes lithium battery technologies and provides for a single integrated power source which can provide for electrical power to a variety of different output ports that each have different supply requirements. Specifically, it can provide power to existing MGS components (33) using legacy connectors, but also can provide power to a night sight system (17) and to other auxiliary electronic devices that may commonly be used by soldiers co-present with the FCS (31) box (131).

The MGS battery system (100) can also take in multiple inputs to supply the power to charge the onboard batteries (161). This can include power supplied by a vehicle's electrical system, by power supplied by more traditional generators or electrical infrastructure, to power from more modern systems such as photovoltaic or kinetic generators. Embodiments of the MGS battery system (100) discussed herein can typically handle multiple inputs and multiple outputs while only utilizing a single power conversion stage for each electrical path. This can provide for improved storage, simplicity of operation and repair, and reduced weight.

There is described herein, in an embodiment, a battery system comprising: a housing; said housing including a top which overhangs a side of said housing, said top including a primary power interface on an underside of said overhang, a night sight output on an upper surface of said top, an auxiliary output on said upper surface, and an input connector on said upper surface; a plurality of battery packs within said housing, said plurality of battery packs electrically connected to electrical conversion circuitry via a battery bus, said electrical conversion circuitry supplying electricity from an input source connected to said input connector to said plurality of battery packs; and an output power board including a battery charge controller providing power to said night sight output and said primary interface exclusively from either said input source or said plurality of battery packs; wherein said battery system is a drop-in substitute for an existing Missile Guidance System (MGS) battery system for a TOW missile; and wherein said electrical output of said primary power interface, said night sight output, and said auxiliary output are different.

In an embodiment of the system, the battery charge controller is assisted by a microprocessor.

In an embodiment of the system, the output of said electrical conversion circuitry is between 12-16 VDC.

In an embodiment of the system, the electrical conversion circuity includes an AC/DC converter.

In an embodiment of the system, the electrical conversion circuitry includes circuitry to handle at least one of: potential overvoltage, transient, reverse polarity and surge protection.

In an embodiment of the system, the auxiliary output is a Universal Serial Bus (USB) PD connector.

In an embodiment, the system further comprises a multi-line display in said top,

In an embodiment of the system, at least one of said battery packs is electrically connected to said battery bus when said input source is connected to said input connector and a load is connected to at least one of said night sight output and said primary interface so electricity from said input connector flows through said battery bus, said at least one battery, and said load.

In an embodiment of the system, the connected battery has a lowest charge of said batteries in said plurality of battery packs

In an embodiment of the system, each battery in said plurality of battery packs is independently connectable to said battery bus.

In an embodiment, the system further comprises a monitoring and feedback circuit.

### BRIEF DESCRIPTION OF THE DRAWINGS

FIG. 1 shows a perspective view of an embodiment of a tripod mount TOW missile platform.

FIG. 2 shows a perspective view of an embodiment of an MGS battery system.

FIG. 3 shows a top view of the embodiment of FIG. 1 to illustrate the controls, inputs, and output interfaces mounted on the top surface.

FIG. 4 shows a photograph illustrating how the embodiment of the MGS battery system provided in FIG. 2 can fit into an existing fire control system (FGS) box.

FIG. 5 shows a photograph of an example of an MGS battery system according to the embodiment of FIG. 2.

FIG. 6 shows a general block diagram of the operational connections in an embodiment of an MGS battery system.

FIG. 7 shows a general block diagram of the subcomponents of the charge and control circuit of FIG. 6.

FIG. 8 shows a general block diagram of the subcomponents of the output power circuit of FIG. 6.

FIG. 9 shows a general block diagram of an isolated voltage and current monitor of FIG. 7.

FIG. 10 shows a photograph illustrating the location of various internal components of the embodiment of MGS battery system of FIG. 5.

### DETAILED DESCRIPTION OF PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives, and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

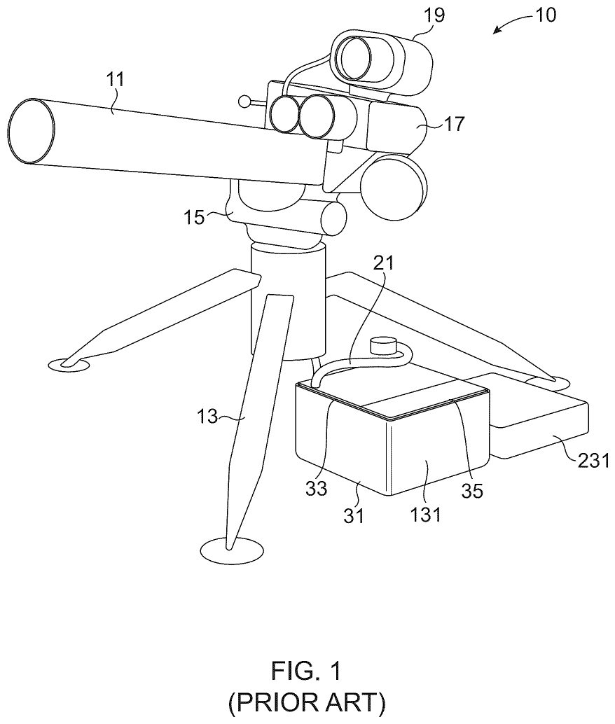

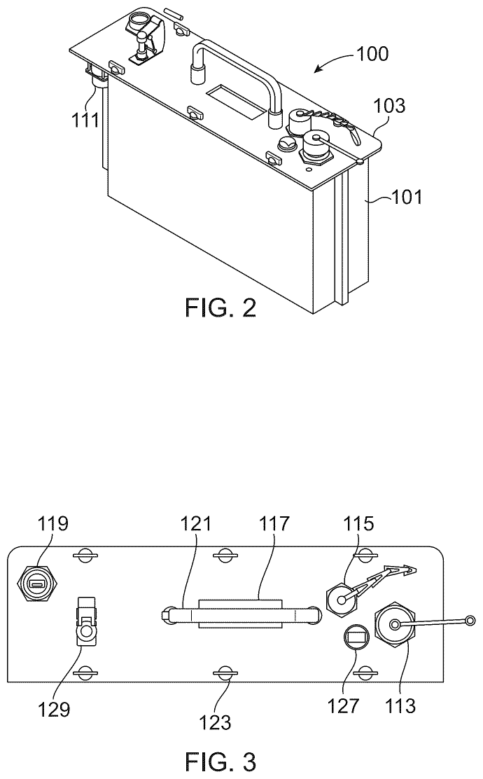

FIG. 2 provides a perspective view of an embodiment of an MGS battery system (100) which is suitable as a drop-in replacement for an existing MGS battery pack (35) designed to be used in an existing FCS (31) box (131) such as that shown in FIG. 1. Thus, this MGS battery system (100) could also be referred to as a Missile Guidance System (MGS) battery pack (35) and is principally designed to operate an infantry portable missile system such as a tripod mounted TOW missile platform (10). The MGS battery system (100) will typically be of most use for a TOW platform that has available a night vision system (19), but that is not required. It should also be recognized that the MGS battery system (100) can be used more generally and may be used as a power source for alternative devices, both for military and non-military use, as appropriate or desired.

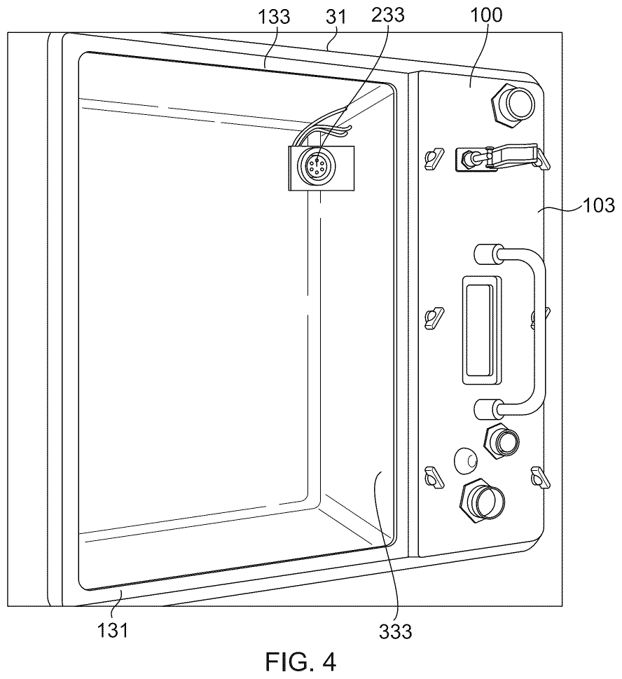

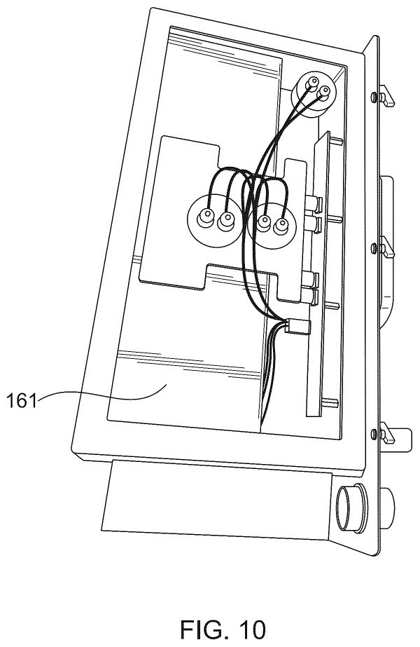

The depicted embodiment of MGS battery system (100) generally includes a housing (101) which serves to encase the various electronic components and the actual batteries (161) themselves and will fit into an existing FCS (31), or other system into which it is to be placed, as a drop-in replacement. An example of this is shown in FIG. 4 where the battery system (100) is shown in a legacy FCS (31) box (131). The batteries (161) will generally be sealed chemical batteries and typically will use some form of lithium-based technology as can be best seen in FIG. 10. This is, however, by no means required and other forms of batteries (161), including non-chemical batteries, may be used. The batteries (161) will generally be designed to be rechargeable in place without removal from the battery system (100).

In FIG. 4, the space (133) into which the MGS (33) would be placed in the box (131) is visible and the space (133) is often separated from the space occupied by the battery system (100) by a structural divider (333). As shown in FIG. 4, the battery system, (100) may be connected to the legacy FCS (31) using legacy fasteners (123) which can interface with the housing box (131) of the FCS (31). It should be recognized that the box (131) will typically include a hinged or removable lid (231) which serves to encase the MGS (31) and battery system (100) within the FCS (31) box (131) but which is designed to be removed or opened during platform (10) operation.

The housing (101) on the top (103) of the battery system (100) will generally include a number of interfaces and controls to interface the battery system (100) to other components when installed in a legacy FCS box (131) and to allow for control of the MGS battery system (100) by a user. Further, data feedback may be provided from the MGS battery system (100) to the user through a series of displays (117), alerts, or other components providing such feedback. When placed in an FCS (31) box (131), most of the housing (101) other than the top (103) is inaccessible, so the top (103) is typically the best, if not only place, to put interfaces and displays (117). The various interfaces and displays (117) are shown in greater detail in FIGS. 3, 4, and 5.

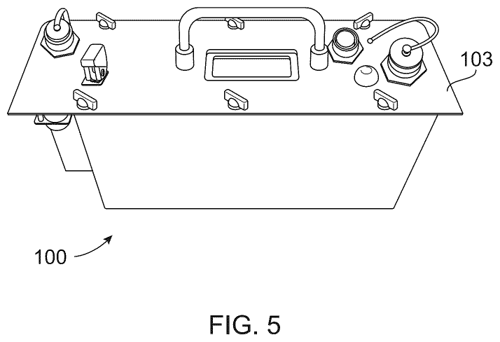

The controls and displays of the MGS battery system (100) are primarily visible in the top down view of FIG. 2 as they are typically located on the top (103) of the housing (101) for ease of access when the top (231) of the FCS (31) box (131) is removed or opened. This is, however, by no means required positioning and the controls and displays may be moved to alternative positions in different embodiments. As a simple example, the primary power interface (111) is actually located on the underside of the top (103) and is not visible in FIG. 3 or 4 but is visible in FIGS. 2 and 5. The primary interface (111) is the power port for providing power output for primary missile functions and specifically for the MGS (33) and platform (10) functions connected to it by the umbilical connection (21). The primary interface (111) typically comprises a blind-mate circular connector which is internal (not visible) to the FCS housing (131) when the battery system (100) is inserted into the box (131). In FIG. 4, the connector (233) is visible which would connect the power from the battery system (100) ultimately to the MGS (33) when the MGS (33) was placed in the space (133).

On the top surface (103), the battery system (100) includes a power input (113) which can be connected to an external source of power. Typically, this will be for charging of the battery system (100). However, should an external source of power be available when the platform (10) is in use, the external power connected via the power input (113) can be used to power components connected to the battery system (100) directly and the connection can bypass the batteries (161). This can allow for increased operational life of the battery system (100) in the field. Also included on the top surface (103) is a night sight output (115). This is for connection to the night sight (17) and for providing power to the night sight (17). A display (117) will also typically be included. The pushbutton (127) may be used to alter the information on the display (117) which can display indicators of battery charge levels, error codes, and other useful information to the operator of the battery system (100).

As opposed to the prior battery pack (35), the battery system (100) may include a larger multi-line display (117). This can allow for more information to be presented to an operator such as, but not limited to, battery charge level and expected run time of various attached components. In an embodiment, the display (117) may include multiple modes of display. In a first mode, the display (117) provides more limited information. For example, if there is an error in the battery system (100) the display may simply indicate an error condition without necessarily giving details. In an alternative mode of operation, the display (117) could provide for details of the specifics of what is causing the error. The two modes can allow different operators using the battery system (100) for different purpose, or at different skill levels, to obtain different information to assist in their use or repair of the battery system (100).

The display (117) may also be designed to operate in a wide variety of conditions, particularly to enhance use outside and exposed to elements as would be expected. For example, the display (117) will typically be visible under multiple lighting conditions including low light and direct sunlight. The display (117) may also be designed to operate in a wide range of temperatures including well below 0° F. and well above 100° F.

In the depicted embodiment, the display (117) is located under a handle (121) as was typical of prior battery packs (35). The handle (121) can be used to separate the battery system (100) from the FGS (31) or can be used to lift or move the FGS (31) as a whole when the battery system (100) is connected. The handle, in an embodiment, can fold or be removable to make the display (117) easier to see.

In addition to having the power outputs in the form of the primary connector (111) and the night sight output (115), the battery system (100) may also include a third power output which, in the depicted embodiment, is in the form of a USB PD connector (119). The USB PD connector (119) can utilize an existing Universal Serial Bus (USB) connection to provide power to other electronic devices. Specifically, many personal electronics, including those useful on the battlefield such as mobile computers of a variety of forms (e.g. laptops, tablets, and smartphones) and even simpler devices such as flashlights and portable radios can have internal batteries charged by, or can operate using, USB Power Delivery (USB PD) standards.

Having the USB PD connector (119) available, therefore, allows for these devices to also be charged using the battery system (100). In the field, this makes the battery system (100) a more general device in that it can act as a larger battery supply for a number of devices and need not be confined to just powering the MGS (33) when the platform (10) is in use as a weapon system. Instead, the FGS (31) box (131) becomes a general battery system (100) for use as a power source for a variety of items. To help fulfill this more general role, in the depicted embodiment, the USB PD connector (119) is in the form of a fully sealed USB Type-A jack compatible with standard USB cables and sealed Molex cables which can support multiple charging standards such as, but not limited to Apple 2.4A and USB-IF BC1.2 charging standards ..

The top (103) also has thereon a power or mode switch (129). This will typically be in the form of a multi-position switch. In the depicted embodiment, this is a three-way switch (129) which allows for operation of the battery system (100) with different selections of items being powered. In this embodiment, the three positions correspond to the system being powered off (which may or may not allow for the USB output (119) to still be used), to the night sight output (115) being powered alone, and to the night sight system (115) and primary interface (111) both being powered. Allowing for the night sight output (115) to be powered alone can provide for increased operational length when the night sight (17) is needed or useful (such as for simple observation), but the platform (10) need not be ready to be actively fired, but the FCS (31) box (131) is still assembled and ready for use.

This once again allows for more general operability of the battery system (100) for a variety of tasks. As a simple example, the night sight system (17) may be used alone such as for nighttime monitoring or sentry duties when the actual missile system is not expected to be needed. Since the night sight (17) only consumes a fraction of the power of the MGS (33) and night sight (17) in combination, this allows for better battery life.

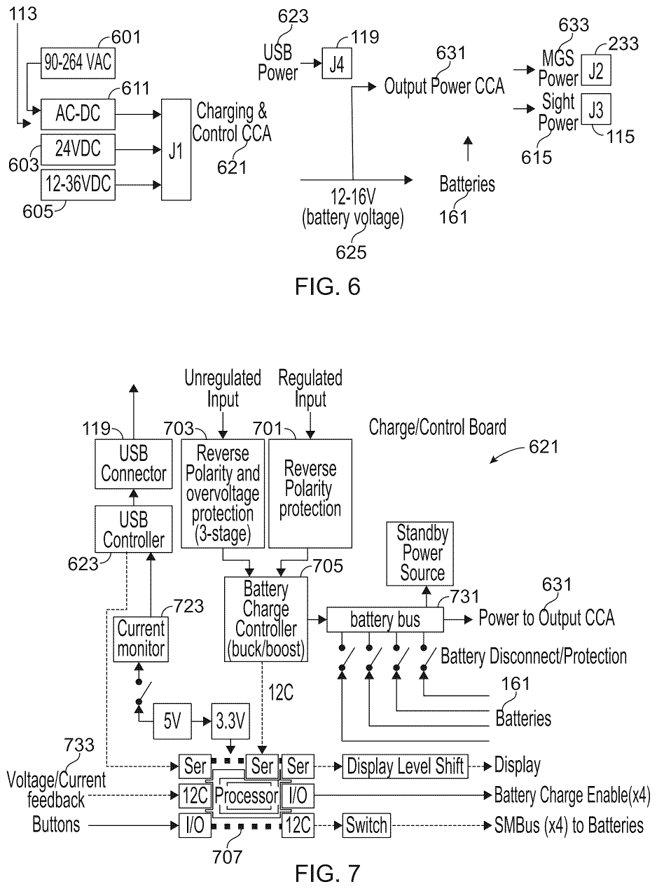

While FIGS. 1-5 have provided an indication of an embodiment of the overall device and how it can interact with the MGS (33) and fit in an existing FCS (31) box (131), FIGS. 6-10 provide for increased detail on the electrical operation and internal operation of an embodiment of the battery system (100).

To begin, FIG. 6 provides for a general block diagram on the operation of the overall electronics of the battery system (100). Specifically, as shown in FIG. 6, a variety of power inputs of both alternating current (AC) and direct current (DC) may be provided to the battery system (100) via the input connector (113). These can include 90-264 VAC sources (601), 24 VDC sources (603), and more common 12-36 VDC sources (605) but any type of source may be planned for depending on embodiment. In the depicted embodiment, the system is designed to accept a wide variety of input sources so that it may be charged under a wide variety of conditions. As such it can also include dedicated surge and/or overcharge protection and reverse polarity protection.

As opposed to needing a dedicated charging station which provides the battery system (100) with a prepared power source of known current and voltage, the battery system, (100) is designed to carry componentry on board so that any source adaptable for connection to the input connector (113) can reasonably be used to charge. This can include, in an embodiment, vehicle-based sources including a vehicle battery or alternator, other battery sources, household or infrastructure based electric grids or systems, or alternative sources such as solar panels or kinetic generators. The battery system (100) may include adapter cables or connectors to connect the input connector (113) to a variety of different sources in an embodiment. Typically, the battery system (100) will be best served by having an input at or above the operating voltage of the internal electronics of the battery system (100). In the depicted embodiment, this is voltages at or above 12 V. However, this level is by no means required and other voltages may be used. In an embodiment, the system (100) may operate directly from an input (113), bypassing the batteries (161) if the input is within operating requirements of the operational voltage.

To provide for the various sources of input being different, the control circuit (621) provides hardware and software to convert from each type of source (601), (603), and (605) to an internally useful voltage and current. In the depicted embodiment, this comprises various hardware circuitry to handle and receive sources of a variety of different inputs and may include hardware and software to convert sources connected thereto into a target amount which will typically be from around 12-16 VDC. Such conversion systems are generally known to those of ordinary skill in the art. If DC sources are connected, the hardware and software typically comprises standard voltage and current regulation. In the case of AC sources, there will usually be an AC/DC converter (611) to convert the AC to DC before supplying it further to the system. In this way, all the electricity provided to the charging and control board (621), which forms the primary electrical components of the battery system (100), will generally be in the form of 12 VDC power.

FIG. 7 provides for a block diagram with increased detail of the operation and components of the charging and control board (621). The charging and control board (621) will generally convert, along with appropriate hardware within the source path (601), (603) and (605), the various input voltages into the appropriate output voltage and supply that voltage and current to the appropriate output. As shown, the board (621) may include protection systems (701) and (703) to inhibit power anomalies from damaging the board (621) or other components. These protection systems can include specialized components to deal with potential overvoltage, transient, reverse polarity and surge protection as deemed appropriate. As indicated above, a 12 VDC result will typically be obtained in the present embodiment from all the available power inputs (113) and will, in an embodiment, be the standard operating voltage of the battery system (100).

Typically, what happens with the input power relative to the outputs, internal electronics and batteries (161) will be controlled by a battery charge controller (705) in combination with a microprocessor (707) which provides digital computer control to the electronics. The charge controller (705) will generally direct power to the output circuit (631) and/or batteries (161) via a battery bus (731). The controller (705) will also supply power to the microprocessor (707). The controller (705), via the battery bus (731), will typically allow the battery system (100) to operate with either the night sight output (115) and primary interface (111) being provided power by the attached power source (113) or by the batteries (161) in an exclusive fashion. Specifically, power is typically primarily directed by the controller (705) to the outputs (115) and (111) from the input (113) or from the batteries (161). In typical operation, in order to provide for uninterrupted power to the load (631), at least one battery will always be connected to the bus. Thus, if outside power is connected at (113), the controller (705) will generally not prioritize sending power to the batteries (161) nor draw from the batteries (161) but the power will be allowed to flow through the bus, and typically at least one of the batteries (161) to the load (631).

However, alternative load cooperation arrangements may be performed in an alternative embodiment. For example, if outside power is connected at (113), the batteries (161) may be totally disconnected. This can provide for no battery draw but could result in a power interruption if the outside power is disconnected and before the batteries (161) can take over supplying power to the load (631). In a still further embodiment, the batteries (161) could be arranged in line with the supply of outside power so that the outside power always charges the batteries (161) and the load (631) always draws from them. In a still further embodiment, the battery system (100) may also use the batteries (161) to supply further power to the outputs (111) and (115) if the input power (113) is too low. However, this is an unlikely scenario.

The battery bus (731) as shown in FIG. 7, will typically serve to connect and disconnect the batteries (161). This can serve to both connect or disconnect them from an input power source (113) and can serve to connect and disconnect them from a load (631). The batteries (161) may comprise a single battery or, as is shown in abstract form in FIG. 7, may comprise a plurality of similar or different batteries. These may connect or be disconnected as if they were a single battery. Alternatively, each battery in the plurality of batteries (161) may be independently interconnectable to the bus (which would typically comprise a plurality of busses in this case) from each other battery. This can provide for improved functionality in operation and charging but may decrease battery life. Specifically, in an embodiment, the battery controller (705) may connect a subset of the batteries (161) to the load (631) while simultaneously attaching a different, and typically non-overlapping, subset of the batteries (161) to the power input (113). In this case, the subset attached to the load would be discharging to power the load (631) while the subset attached to the input (113) was being charged.

The controller (705) may include finer control over each individual battery or subset even than the above. For example, if two of four batteries (161) have lower charge than the other two while all are to be charged, the controller (705) may prioritize charging of those with lower charge until the amounts are all equal, and then charge all at the same rate. In this scenario, the battery level across the batteries is maintained at the same amount so that when they are discharged together, they will discharge more efficiently. A similar scenario may be used if the batteries (161) are not being charged but are connected to a load (631) and have different relative charges. In this case, the batteries (161) may be discharged with the highest charged individuals or subsets discharged until they are at equal charge to the next level down, those are then discharged together, and so forth until all the batteries have essentially the same charge and are being discharged together.

Individual battery connection via the bus (731) provides for still additional functionality. In particular, should battery be damaged or otherwise malfunction, the controller (705) may simply remove it from use and utilize only the other functioning parts of the batteries (161). In a more advanced embodiment, the batteries (161) may include a number of different types of batteries (161) or those having different profiles. In this situation, the controller (705) may actually select a sub-component battery optimized for the current load (631) or input (113) to utilize or charge first. This can allow for potentially improved system (100) operation without substantial alteration of structure or weight, so long as use and/or charging is along expected and predetermined parameters.

As is broadly illustrated in FIG. 7, the microprocessor (707) serves to control and operate the various components of the board (621). It may also control and operate other components including the monitors of FIG. 9 and/or outputs and related systems utilized by a user. In an embodiment, because of the nature of the voltage required by USB output (119) (which is typically below that used by the microprocessor (707)), the microprocessor (707) will typically serve to direct appropriate USB power (623) through the board (621) to the USB output (119). The microprocessor (707) will also typically power and control other components such as the overall control on the battery (161) operation (such as it being connected or disconnected to the battery bus (731), the charging process, and the display (117)). Via the display (117), the microprocessor (707) may supply information to a user.

In the above discussion, it is presumed that the battery system (100) is operating connected to an external power source via the power input (113). This will typically be the situation when the battery system (100) is being charged or has access to such external power. However, should no external power source (113) be available, the microprocessor (707) may also obtain power from the batteries (161) so that the battery system (113) may operate in basically the same way, but without the need for an external power hookup. A switch may be provided in this case so that the microprocessor (707) will operate if an external power source is connected to the input (113) but can be disabled to save power if no such source is connected. In this case, when it is needed, the microprocessor (707) would use battery (161) power.

As part of the microprocessor (707) operation, it will also typically monitor the various outputs and inputs to locate and notify the user of problems in operation and to avoid damage from malfunctioning components and may supply indications of fault and the like to the user. As shown in FIG. 7, the microcontroller may provide monitors for the USB output (199) via monitoring circuit (723) and may provide for more general monitoring by controlling a monitor and feedback system (733) for the various inputs and outputs. The output of the monitors (733) may be displayed on the display (117) which may also be used to display charging status, charging levels or error messages related to the output of the monitors and the status of the batteries (161).

The microprocessor (707) can also serve to balance load between various elements within the batteries (161). As an example, the batteries (161) will typically include a number of subcomponent battery structures. The microprocessor (707) may act to make sure that these stay charged to generally the same level. Thus, when charging, input power (113) may be sent to the subcomponent batteries in batteries (161) at different levels. The subcomponent batteries of batteries (161) may also be drained at different rates.

Outside of the USB output (119), power transmission to the other outputs (111) and (115) will be controlled by the circuit (631) which can supply appropriate voltage (615) for the night sight (17) to the night sight connector (119) and/or can supply appropriate voltage (633) for the MGS (33) to the primary interface (111). As the connectors are different, the circuit (631) will typically be able to have either power available at any time when an external power source is connected to the input (113) and the power mode switch (129) is set to provide power to both of them.

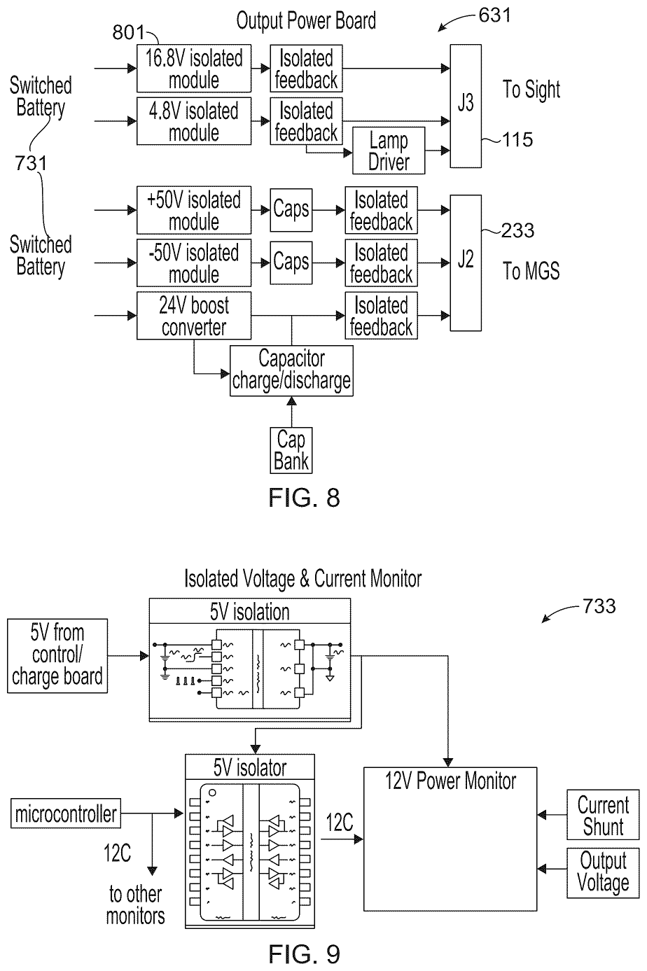

FIG. 8 provides increased detail on the operation of the board (631) for supplying power to the main components of the platform (10) via the primary interface (111) and night sight connector (115). The power supplied to one or both of these outputs may come from the batteries (161) or directly from the input (113) via the bus (731) and controller (705). In an alternative embodiment, specific components or batteries within the batteries (161) may supply power directly to the primary interface (111) and/or night sight output (115). Regardless of the source, the power input (113) will generally be converted into a single voltage for the battery bus (731), and the output power board (631) will generally convert that to a plurality of different voltages and powers via modules (801). This is typically because both the night sight output (115) and primary interface (111) utilize more than one single type of power due to their internal complexity. In an embodiment of the system, this modification is, however, performed a single time. That is, the battery or input power, once converted to the 12V operating power (which is the standard power of the batteries (161) also) is only converted a single time to generate the output power for any of the connectors (115), (119), and (111). Thus, each output pathway utilizes just one power conversion stage. This can provide for increased efficiency and reliability of operation of the battery system (100). The system (100) also typically needs to make sure that there are no concerns with power mismatch which could result in damage to the platform (10) components.

FIG. 9 provides increased detail on an embodiment of a monitoring and feedback circuit (733). One of these circuits may be provided to monitor any or all of the power outputs associated with any or all of the output connections (115), (111), and/or (219). In an embodiment, there will be a calibration step at an acceptance test level with an offset and scale number for each monitor circuit to make sure that the system (100) functions properly.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “perpendicular” are purely geometric constructs and no real-world component or relationship is truly “perpendicular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A battery system comprising:
a housing;
said housing including a top which overhangs a side of said housing, said top including a primary power interface on an underside of said overhang, a night sight output on an upper surface of said top, an auxiliary output on said upper surface, and an input connector on said upper surface;
a plurality of battery packs within said housing, said plurality of battery packs electrically connected to electrical conversion circuitry via a battery bus, said electrical conversion circuitry supplying electricity from an input source connected to said input connector to said plurality of battery packs; and
an output power board including a battery charge controller providing power to said night sight output and said primary interface exclusively from either said input source or said plurality of battery packs;
wherein said battery system is a drop-in substitute for an existing Missile Guidance System (MGS) battery system for a TOW missile; and
wherein said electrical output of said primary power interface, said night sight output, and said auxiliary output are different.

2. The system of claim 1, wherein said battery charge controller is assisted by a microprocessor.

3. The system of claim 1, wherein output of said electrical conversion circuitry is between 12-16 VDC.

4. The system of claim 1, wherein said electrical conversion circuity includes an AC/DC converter.

5. The system of claim 1, wherein said electrical conversion circuitry includes circuitry to handle at least one of: potential overvoltage, transient, reverse polarity and surge protection.

6. The system of claim 1, wherein said auxiliary output is a Universal Serial Bus (USB) PD connector.

7. The system of claim 1, further comprising a multi-line display in said top.

8. The system of claim 1, wherein at least one of said battery packs is electrically connected to said battery bus when said input source is connected to said input connector and a load is connected to at least one of said night sight output and said primary interface so electricity from said input connector flows through said battery bus, said at least one battery, and said load.

9. The system of claim 8, wherein said connected battery has a lowest charge of said batteries in said plurality of battery packs.

10. The system of claim 1, wherein each said battery in said plurality of battery packs is independently connectable to said battery bus.

11. The system of claim 1, further comprising a monitoring and feedback circuit.
